(19) United States
(12) Patent Application Publication
(10) Pub. No.: US 2020/0258193 A1
(43) Pub. Date: Aug. 13, 2020

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: Takanori Katsumata, Tokyo (JP)

(21) Appl. No.: 16/784,158

(22) Filed: Feb. 6, 2020

(30) Foreign Application Priority Data
Feb. 7, 2019 (JP) 2019-020355

(51) Int. Cl. G06T 3/20; G06T 3/60; G06T 11/00; G06F 3/033

(52) U.S. Cl. CPC G06T 3/20; G06T 3/60; G06T 2200/24; G06F 3/033; G06T 11/00

(57) ABSTRACT

An information processing apparatus that displays an image including a virtual object, on a display device configured to display an image observed by a user, includes a setting unit configured to set, on the virtual object, a manipulation point used to manipulate the virtual object based on manipulation by the user, a generation unit configured to generate, based on the position of the manipulation point, a manipulation axis to be used when the virtual object is moved, and a moving unit configured to move the virtual object by using the manipulation axis.

### BACKGROUND

### Field of the Disclosure

The present disclosure relates to an information processing apparatus that displays, on a display device, an image including a virtual object.

### Description of the Related Art

Research on mixed reality (MR) systems has been actively conducted to achieve seamless combination of a real space and a virtual space. For example, a head mounted display (HMD) can be used as an image display device that presents these systems.

There has been known a technique for manipulating arrangement of virtual object in an MR space in which a real space and a virtual object are combined. Examples of such a technique includes a technique that allows a user to select a virtual object 6030 and move the object in a desired direction by using a virtual laser beam 6200 output from a virtual laser device 5010 held by a user's hand, as illustrated in FIGS. 6A and 6B. For example, Japanese Patent Application Laid-Open No. 11-316858 discusses a method in which a grid of orthogonal coordinates is created in a virtual space, and a virtual object is rearranged on the grid.

Further, Japanese Patent Application Laid-Open No. 2017-84323 discusses a technique in which a movement direction is constrained to an axis automatically selected from X, Y, and Z axes in the world coordinate system, to improve usability of manipulating a virtual object by an HMD wearer.

### SUMMARY

In the method discussed in Japanese Patent Application Laid-Open No. 2017-84323, any of an upward direction with respect to a user, a direction of the visual line of the user, and a direction perpendicular to the upward direction and the direction of the visual line is used as a reference, and an axis which is one of the axes in the world coordinate system and has the smallest angle with respect to the reference axis is set as a constraint axis. In this method, the constraint axis is limited to the axes in the world coordinate system, and thus movement of a virtual object along an axis in a local coordinate system of the virtual object is not supported. Further, since it is necessary to set a method for determining a constraint axis in advance, that method is not suitable for a user who is not accustomed to the manipulation, and it is difficult to move a virtual object along a local coordinate. The present invention has been made in view of the above issues. The present invention is directed to a technique for easily moving a virtual object by using a manipulation axis, in an information processing apparatus that displays, on a display device, an image including a virtual object.

According to an aspect of the present disclosure, an information processing apparatus that displays an image including a virtual object, on a display device configured to display an image observed by a user, includes a setting unit configured to set, on the virtual object, a manipulation point used to manipulate the virtual object based on manipulation by the user, a generation unit configured to generate, based on the position of the manipulation point, a manipulation axis to be used when the virtual object is moved, and a moving unit configured to move the virtual object by using the manipulation axis.

Further features of the present disclosure will become apparent from the following description of exemplary embodiments with reference to the attached drawings.

### BRIEF DESCRIPTION OF THE DRAWINGS

FIG. 1 is a block diagram of an example of a functional configuration of a system according to one or more aspects of the present disclosure.

FIG. 2 is a flowchart illustrating processing for calculating a manipulation start point, in the information processing apparatus according to one or more aspects of the present disclosure.

FIG. 3 is a flowchart illustrating processing for generating a manipulation axis, in the information processing apparatus according to one or more aspects of the present disclosure.

FIG. 4 is a flowchart illustrating processing for generating a manipulation reference axis and performing manipulation, in the information processing apparatus according to one or more aspects of the present disclosure.

FIGS. 5A and 5B are diagrams schematically illustrating the processing for calculating the manipulation start point, in the information processing apparatus according to one or more aspects of the present disclosure.

FIGS. 6A and 6B are diagrams schematically illustrating the processing for generating the manipulation reference axis and performing manipulation, in the information processing apparatus according to one or more aspects of the present disclosure.

FIG. 7 is a diagram schematically illustrating manipulation of a virtual object in a mixed reality system.

### DESCRIPTION OF THE EMBODIMENTS

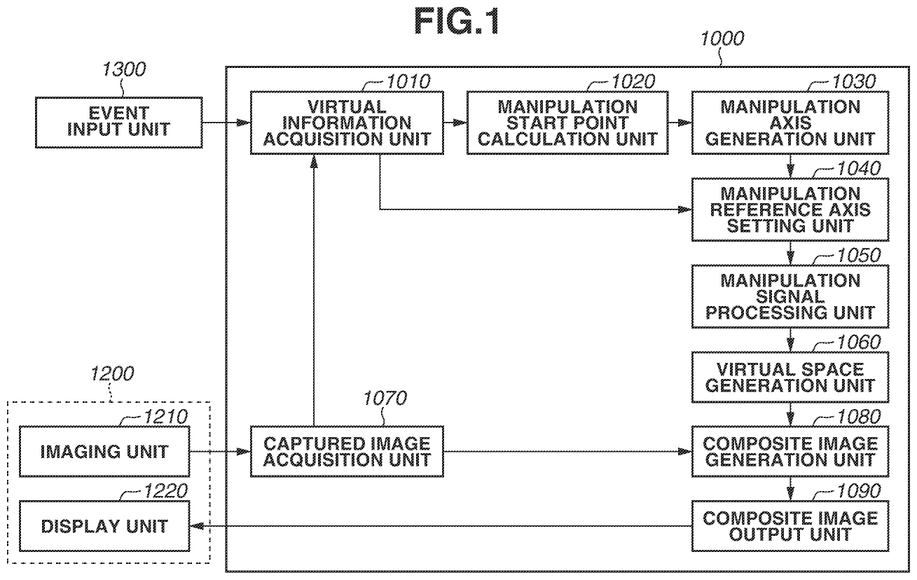

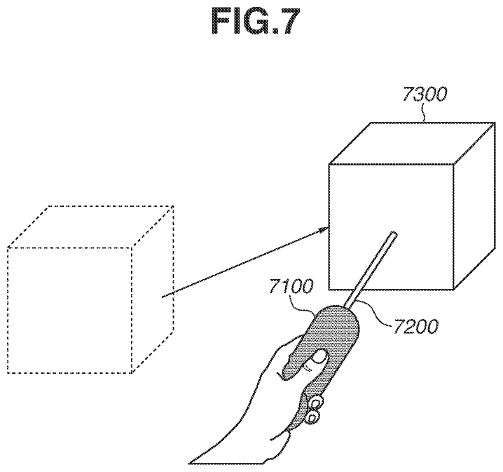

FIG. 7 is a schematic diagram illustrating a state where a computer graphics model (CG model) in a virtual space is moved by using an external device. FIG. 1 is a block diagram illustrating an example of a functional configuration of a system according to an exemplary embodiment. As illustrated in FIG. 1, the system according to the present exemplary embodiment includes an information processing apparatus 1000, a head mounted display (HMD) 1200, which is an example of a head mounted display device used by a user, and an event input unit 1300 configured to input an event from the user.

The HMD 1200 includes a built-in display device, and a user visually observes an image displayed on the display device. The information processing apparatus 1000 has a configuration and functions similar to those of a typical personal computer and includes the following components. Specifically, a virtual information acquisition unit 1010, a manipulation start point calculation unit 1020, a manipulation axis generation unit 1030, a manipulation reference axis setting unit 1040, a manipulation signal processing unit 1050, a virtual space generation unit 1060, a captured image acquisition unit 1070, a composite image generation unit 1080, and a composite image output unit 1090.

In this configuration, the information processing apparatus 1000 and the HMD 1200 are connected so that data communication therebetween is possible. The connection between the information processing apparatus 1000 and the HMD 1200 may be a wired connection or a wireless connection. The information processing apparatus 1000 according to the present exemplary embodiment combines an image of a virtual object and an image of a real space received from an imaging unit 1210 in the HMD 1200 via the captured image acquisition unit 1070, and outputs the composite image, as a mixed reality image, to a display unit 1220 in the HMD 1200.

Next, an operation of the information processing apparatus 1000 will be described.

The imaging unit 1210 captures the real space and input the captured stereoscopic image into the captured image acquisition unit 1070. The captured stereoscopic image and an image of a CG model generated by the virtual space generation unit 1060 are combined by the composite image generation unit 1080, and the composite image is displayed on the display unit 1220.

The virtual information acquisition unit 1010 acquires the position and orientation of the imaging unit 1210 with respect to a predetermined world coordinate system. Examples of methods for acquiring the position and orientation of the imaging unit 1210 include a method in which an image of a marker placed in the real space is captured by the imaging unit 1210, and based on the information on the marker in the image, the position and orientation of the imaging unit 1210 is calculated. Alternatively, another method such as a method using a motion capture system or a method utilizing Simultaneous Localization and Mapping (SLAM) using a captured image may be used.

The manipulation start point calculation unit 1020 calculates a manipulation start point at which manipulation for a CG model 7300 is started based on the CG model and the coordinates in the world coordinate system of an external device 7100, which is an object in the real space, to be manipulated. The object 7100 in the real space may have any configuration as long as the 3D coordinates and orientation of the object 7100 can be determined through the HMD 1200. For example, there is a known method in which two images of an object in the real space are acquired by the imaging unit 1210, the contour of the object is extracted from each of the two images, and, based on them, stereo matching is performed to acquire a group of 3D coordinates of vertices included in a 3D contour. Furthermore, it may be possible to use a device including a rod-shaped body that has a size allowing a user to hold the rod-shaped body with one of the user's hands and that has a vertex on which a virtual laser beam CG is superimposed. Alternatively, it is possible to use input from a controller device for performing manipulation in a virtual space. That vertex is defined as a manipulation point for selecting and manipulating a CG model, and, when the manipulation point is in contact with the CG model 7300 in the virtual space, the manipulation start point is generated on the CG model.

In FIG. 7, which is a schematic diagram illustrating a state where a CG model in the virtual space is moved by using an external device, a virtual laser beam 7200 is generated based on position information of the external device 7100, and an end of the laser beam is set as the manipulation point. In this case, once the manipulation point selects the CG model 7300 and a trigger is input from the external device 7100, the position of the manipulation point at that time is set as the manipulation start point, processing of holding the CG model is performed, and the CG model becomes movable toward any position.

In the present exemplary embodiment, such movement is performed by using the manipulation start point and a manipulation axis, and thus a CG manipulation method allowing for achieving higher usability is provided.

The manipulation axis generation unit 1030 generates the manipulation axis based on a predetermined setting from the virtual information acquisition unit 1010, the manipulation start point calculation unit 1020, and information on the position and orientation. The manipulation axis is displayed to the user to limit the direction of movement for the purpose of improving usability when the CG model is moved. The CG model is processed so as to move along the axis. The predetermined setting may be, for example, a total of six directions, which are the positive and negative directions along the X, Y, and Z axes in the world coordinate system, or may be any one of the six directions. Further, the type of movement is not limited to linear movement, and a manipulation axis for rotational movement may be used. The radius of the rotation axis is, for example, the distance between the center of the CG model that is in contact with the manipulation start point and the manipulation start point. As for the center of the rotation axis, the circle is centered on the manipulation axes extending in the total of six directions, which are the positive and negative directions along the X, Y, and Z axes when the center of the CG model is set as the origin. Any one of the six directions, which are the positive and negative directions along the X, Y, and Z axes may be set as the center of the rotation axis.

In addition, a total of six directions of the positive and negative directions along the X, Y, and Z axes with respect to a local coordinate system, which is an coordinate system that each object in the 3D space has, may be used or any one of the six directions may be used.

When a trigger signal for executing a predetermined function is input, a manipulation axis with an origin set at a manipulation start point is generated. In the present exemplary embodiment, a button press at the controller device is used as an example of a trigger signal input. However, the signal may be generated by using a gesture based on time-series changes of the position of the manipulation point or user interface control other than a button.

Based on the position and movement of the manipulation start point, and relative position and movement between the manipulation start point and a CG model or a user interface control, the manipulation reference axis setting unit 1040 determine a single manipulation reference axis to be used as a reference of a direction of manipulation, from the manipulation axes. The direction of manipulation is, for example, any of the directions along the X, Y, and Z axes, along which the greatest movement is observed based on the difference between the coordinates of the manipulation start point and the coordinates of the manipulation point at the current frame. The manipulation reference axis is set as the direction of manipulation, and the CG model can be moved only in a single direction along the manipulation reference axis.

The manipulation signal processing unit 1050 generates a signal for executing a predetermined function based on the direction of the manipulation reference axis and a direction of a positional change of the manipulation point. In the present exemplary embodiment, an example is described in which a signal of movement manipulation is generated based on time-series changes of the position of the manipulation point and the direction of the manipulation reference axis.

The virtual space generation unit 1060 stores data of a CG model to be displayed in the mixed reality (MR) space, a CG model of a pointer that indicates, to a user, the position of the manipulation start point, and a CG model of the manipulation reference axis displayed by using the manipulation start point as a reference. In addition to the data, a processing result and the like caused due to the manipulation signal is rendered in a manner consistent with the stereoscopic image of the real space by using the position and orientation information of the captured image acquisition unit 1070.

The composite image generation unit 1080 combines the stereoscopic image of the real space and an image generated by the virtual space generation unit 1060. At this time, the object in the real space used for extracting the manipulation point is combined in a manner that consistency in a concealment relationship with respect to the CG model in the depth direction is kept, by using the 3D contour information of the object.

The composite image output unit 1090 sends, to the display unit 1220, the composite image generated by the composite image generation unit 1080 to present the composite image to a person who is experiencing the MR system. In the present exemplary embodiment, a display built in the HMD 1200 is used.

### Processing Procedure and Details

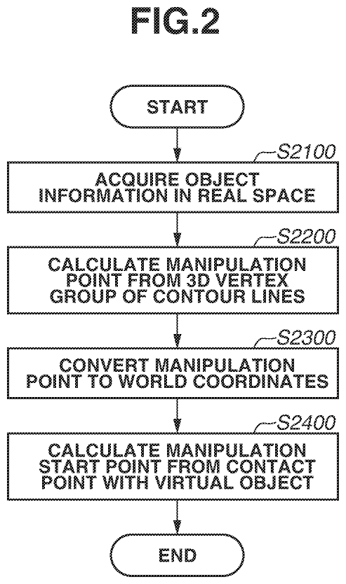

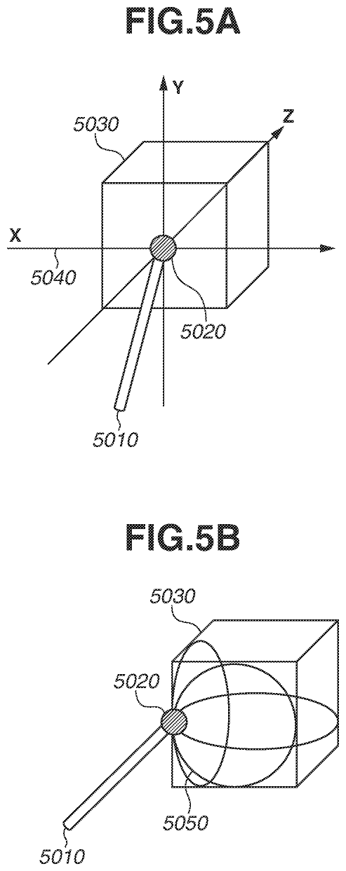

Next, a series of processes in the manipulation start point calculation unit 1020 for calculating the manipulation start point will be described with reference a flow chart of the processes in FIG. 2. Moreover, the processes are also schematically illustrated in FIGS. 5A and 5B.

In Step S2100, coordinates of a vertex of a virtual laser device 5010 in the real space to be used for manipulation is acquired. The captured image acquisition unit 1070 acquires the background image, the position and orientation information of the imaging apparatus, superimposes the virtual laser device 5010 on the object in the real space, and acquires the display position of the virtual object. The method for detecting the object in the real space may be based on image processing in which a feature point of a marker is detected, or may be a method in which a user is detected based on position information from a position and orientation sensor.

In step S2200, a manipulation point is selected, based on a predetermined feature, from a plurality of corresponding points of depth information of the virtual laser device 5010 acquired from the captured image. For example, as for depth information, at first, an epipolar line corresponding to a sampling point on a contour line in one of the stereoscopic images, is projected onto the other of the stereoscopic images, and the intersection of the epipolar line and the contour line is determined as a corresponding point. A method is known in which a plurality of sampling points on the contour line is determined, and depth is calculated by performing triangulation with respect to a plurality of corresponding points on the contour line for acquiring a plurality of corresponding points on the contour line.

In the present exemplary embodiment, a corresponding point having the coordinate values of the end when it is projected onto the image in which the corresponding points are acquired is set as the manipulation point.

In step S2300, coordinate conversion of the manipulation point selected in step S2200 into coordinates in the world coordinate system is performed, based on the information on the orientation of the HMD 1200.

In step S2400, a contact determination between the manipulation point and the CG model 5030 in the virtual space is performed. In the present exemplary embodiment, in order to determine contact between the manipulation point that is a 3D point and the CG model 5030 formed by polygon surfaces, the position of the manipulation point at the previous frame and the position of the manipulation point at the current frame are connected to form a line segment. When the intersection of this line segment and the polygon of the CG model 5030 exists, it is determined that contact occurs. Alternatively, it may be possible to use a method in which a predetermined 3D area is defined with respect to the manipulation point, and contact is determined based on whether an intersection of a plane or a line segment forming the 3D area and the CG model 5030 exits or not. When it is determined that contact occurs, the manipulation point is set as the manipulation start point 5020 and the manipulation pointer is rendered by the virtual space generation unit 1060.

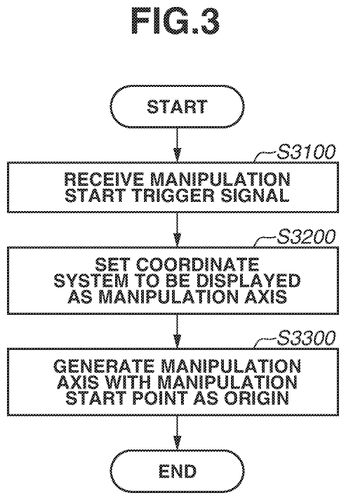

Next, a series of processes by the manipulation axis generation unit 1030 to generate the manipulation axis will be described with reference to a flowchart of the processes illustrated in FIG. 3, as well as FIGS. 5A and SB.

In step S3100, an input of a trigger signal from a controller device for selecting the CG model 5030 is recognized.

In step S3200, a setting of a manipulation axis 5040 that is set in advance is read. This setting item includes, for example, whether all of X, Y, and Z axes are displayed or a single direction is displayed, or whether the world coordinate system or the local coordinate system of the CG model 5030 is selected.

In step S3300, based on the manipulation start point 5020 and the settings of the manipulation axis 5040, the manipulation axis 5040 with an origin being set at the manipulation start point 5020 is generated. In the present exemplary embodiment, the six directions of the positive and negative directions along the X, Y, and Z axes in the world coordinate system are generated. FIG. 5A illustrates axes displayed when the CG model 5030 is linearly moved along an axis, and FIG. 5B illustrates an example of axes displayed when the CG model 5030 is rotated along an axis. The manipulation axis 5050 in FIG. 5B is a display of a circle with a radius equal to the distance between the center of the CG model 5030 in contact with the manipulation point and the manipulation start point 5020, and indicates that the CG model 5030 can be rotated along the circumference of the circle.

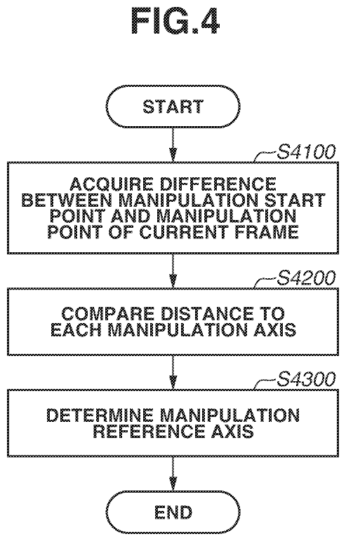

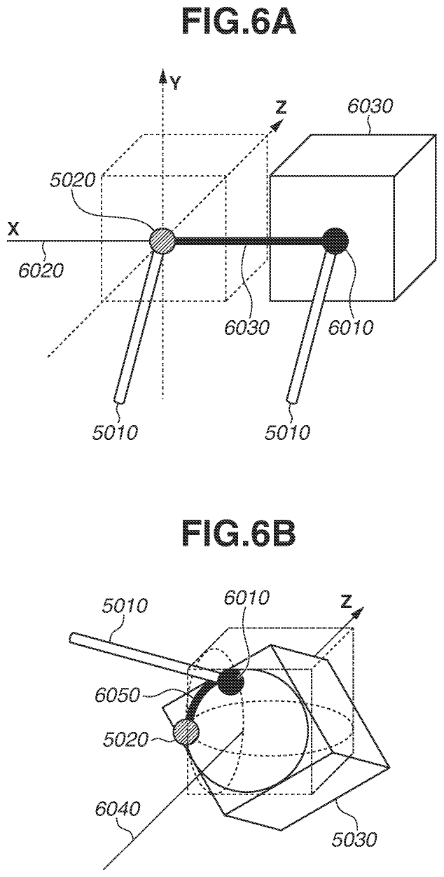

Next, a series of processes for calculating the manipulation reference axis will be described with reference to a flow chart of the processes in FIG. 4. Further, the processes are also schematically illustrated in FIGS. 6A and 6B.

In step S4100, the difference between the position of the manipulation start point 5020 and the position of the manipulation point 6010 at the current frame is acquired to determine whether the CG model 5030 is moved. It may be determined that the CG model 5030 is moved when the amount of the difference is 0 or more, or a threshold value may be set in advance. For example, in a case of performing rotation based on the manipulation reference axis 6050, with regard to which axis is selected for the rotation, the following rules may be set in order to prevent an unintended axis selection by the user. On the three circumferences of X, Y, and Z in FIG. 6A, when the distance between the manipulation point 6010 at the current frame and the manipulation start point 5020 is within 30 mm, the axis of the circle to which a point closest to that manipulation point 6010 belongs is selected, and thereby it is possible to prevent transition to an axis of another circle.

In step S4200, distances, from the position of the manipulation point at the current frame to the manipulation axes 5040 are calculated, and the closest axis is set as the manipulation reference axis 6040. FIG. 6A illustrates an example of movement along the X-axis, and FIG. 6B illustrates an example of rotating manipulation when the Z-axis is the manipulation reference axis. At this time, the distance between the manipulation start point 5020 and the manipulation point at the current frame on the manipulation reference axis may be rendered as a distance by which the CG model 5030 is moved or rotated.

Although in the above-described exemplary embodiment, the CG model manipulation in the MR space is described, it can also be used for virtual reality (VR) in which manipulation in a virtual space can be performed by using a manipulation device.

### Other Exemplary Embodiments

The present disclosure may also be embodied by processing in which a program that realizes one or more functions according to the above-described exemplary embodiment is provided to a system or an apparatus through a network or a storage medium, and one or more processors in a computer of the system or the apparatus read and execute the program. The present disclosure may also be embodied by a circuit (e.g., an application-specific integrated circuit (ASIC)) that realizes one or more functions.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, the scope of the following claims are to be accorded the broadest interpretation so as to encompass all such modifications and equivalent structures and functions.

This application claims the benefit of Japanese Patent Application No. 2019-020355, filed Feb. 7, 2019, which is hereby incorporated by reference herein in its entirety.

What is claimed is:

1. An information processing apparatus that displays an image including a virtual object, on a display device configured to display an image observed by a user, the information processing apparatus comprising:
a setting unit configured to set, on the virtual object, a manipulation point used to manipulate the virtual object based on manipulation by the user;
a generation unit configured to generate, based on the position of the manipulation point, a manipulation axis to be used when the virtual object is moved; and
a moving unit configured to move the virtual object by using the manipulation axis.

2. The information processing apparatus according to claim 1, wherein the moving unit is configured to linearly move the virtual object along the manipulation axis, corresponding to a movement of the manipulation point and.

[symbol]

3. The information processing apparatus according to claim 1, wherein the moving unit is configured to rotationally move the virtual object, corresponding to a movement of the manipulation point and, by using the manipulation axis as a rotation axis.

4. The information processing apparatus according to claim 3,
wherein the manipulation axis includes a plurality of axes, and
wherein the moving unit is configured to select, corresponding to a position of the manipulation point, an axis to be used as the rotation axis, from the plurality of axes.

5. The information processing apparatus according to claim 1, wherein the manipulation axis includes three axes.

6. The information processing apparatus according to claim 1, wherein the image including the virtual object is a composite image of the virtual object and an image of a real space.

7. The information processing apparatus according to claim 1, wherein the setting unit is configured to set, as the manipulation point, an intersection of a laser beam from a virtual laser device manipulated by the user and the virtual object.

8. The information processing apparatus according to claim 1, wherein the display device and the information processing apparatus are connected wirelessly.

9. The information processing apparatus according to claim 1, wherein the display device is a head mounted display.

10. An information processing method for displaying an image including a virtual object, on a display device configured to display an image observed by a user, the method comprising:
setting, on the virtual object, a manipulation point used to manipulate the virtual object based on manipulation by the user;
generating, based on the position of the manipulation point, a manipulation axis used when the virtual object is moved; and
moving the virtual object by using the manipulation axis.

11. The information processing method according to claim 10, wherein, in the moving, the virtual object is moved linearly along the manipulation axis, corresponding to a movement of the manipulation point.

12. The information processing method according to claim 10, wherein, in the moving, the virtual object is moved rotationally by using the manipulation axis as a rotation axis, corresponding to a movement of the manipulation point.

13. The information processing method according to claim 12,
wherein the manipulation axis includes a plurality of axes, and
wherein, in the moving, an axis to be used as the rotation axis is selected, based on a position of the manipulation point, from the plurality of axes.

14. The information processing method according to claim 10, wherein the manipulation axis includes three axes.

15. The information processing method according to claim 10, wherein the image including the virtual object is a composite image of the virtual object and an image of a real space.

16. The information processing method according to claim 10, wherein, in the setting, an intersection of a laser beam from a virtual laser device manipulated by the user and the virtual object is set as the manipulation point.

17. The information processing method according to claim 10, wherein the display device and the information processing apparatus are connected wirelessly.

18. The information processing method according to claim 10, wherein the display device is a head mounted display.

19. A non-transitory storage medium storing a program causing a computer to execute an information processing method for displaying an image including a virtual object, on a display device configured to display an image observed by a user, the method comprising:
setting, on the virtual object, a manipulation point used to manipulate the virtual object based on manipulation by the user;
generating, based on the position of the manipulation point, a manipulation axis used when the virtual object is moved; and
moving the virtual object by using the manipulation axis.

20. The non-transitory storage medium according to claim 19, wherein, in the moving, the virtual object is moved linearly along the manipulation axis, corresponding to a movement of the manipulation point.
